(19) United States
(12) Patent Application Publication
(10) Pub. No.: US 2016/0188455 A1
(43) Pub. Date: Jun. 30, 2016

(54) Systems and Methods for Choosing a Memory Block for the Storage of Data Based on a Frequency With Which the Data is Updated

(71) Applicant: SanDisk Technologies Inc., Plano, TX (US)

(72) Inventor: Leena Patel, Edinburgh (GB)

(73) Assignee: SanDisk Technologies Inc., Plano, TX (US)

(21) Appl. No.: 14/584,388

(22) Filed: Dec. 29, 2014

(51) Int. Cl. G06F 12/02

(52) U.S. Cl. CPC G06F 12/0238; G06F 2212/1044

(57) ABSTRACT

Systems and methods for choosing a memory block for the storage of data based on a frequency with which data is updated are disclosed. In one implementation, a memory management module of a non-volatile memory system receives a request to open a free memory block for the storage of data. The memory management module determines a frequency with which the data is updated. The memory management module then opens a memory block of a first portion a free block list that is associated with low program/erase cycle counts in response to determining that the data will be frequently updated or opens a memory block of a second different portion of the free block list that is associated with high program/erase cycle counts in response to determining that the data is not frequently updated. The memory management module then stores the data in the open memory block of the non-volatile memory.

### BACKGROUND

When opening memory blocks to store data, conventional non-volatile memory systems open a memory block from a free block list within the memory system that is associated with a lowest program/erase cycle count. This procedure is inefficient when data that is not frequently updated is stored in a memory block having a low program/erase cycle count in comparison to other memory blocks at the memory system.

Because the data is not frequently updated, the program/erase cycle count associated with the memory block stays low in comparison to the other memory blocks at the memory system. When the memory system performs wear-leveling operations in order to keep the program/erase cycle count of the memory blocks within the memory system within a defined range of each other, the memory system will move the infrequently updated data in the memory block associated with a low program/erase cycle count to another memory block.

It would be desirable for non-volatile memory systems to consider how often data is updated when choosing a block for the storage of that data in order to reduce a number of wear-leveling operations within the memory system.

### SUMMARY

In one aspect, a method is disclosed. The elements of the method are performed in a memory management module of a non-volatile memory system that is coupled with a host device. In the method, a memory management module receives a request to open a free block of a non-volatile memory of the non-volatile memory system for the storage of data.

The memory management module determines a frequency with which the data is updated. The memory management module opens a memory block of a first portion a free block list that is associated with low program/erase cycle counts in response to determining that the data will be frequently updated or the memory management module opens a memory block of a second different portion of the free block list that is associated with high program/erase cycle counts in response to determining that the data is not frequently updated. The memory management module then stores the data in the open memory block of the non-volatile memory.

In another aspect an apparatus is disclosed. The apparatus includes a non-volatile memory and processing circuitry in communication with the non-volatile memory.

The processing circuitry includes a memory management module that is configured to determine a frequency with which data is updated; select a memory block of the non-volatile memory to store the data based on how many future program/erase cycles that the block of memory can sustain and how frequently the data is updated; and open the selected memory block and store the data at the selected memory block of non-volatile memory.

In another aspect, another method is disclosed. The elements of the method occur in a memory management module of a non-volatile memory system that is coupled to a host device. The memory management module classifies data based on a temperature of the data. The memory management module selects a free memory block of a non-volatile memory of the memory system that complements the data based on a program/erase cycle count associated with the memory block and the temperature of the data. The memory management module then stores the data at the selected memory block.

### BRIEF DESCRIPTION OF THE DRAWINGS

FIG. 1A is a block diagram of an example non-volatile memory system.

FIG. 1B is a block diagram illustrating an exemplary storage module.

FIG. 1C is a block diagram illustrating a hierarchical storage system.

FIG. 2A is a block diagram illustrating exemplary components of a controller of a non-volatile memory system.

FIG. 2B is a block diagram illustrating exemplary components of a non-volatile memory of a non-volatile memory storage system.

FIG. 3 illustrates an example physical memory organization of a memory bank.

FIG. 4 shows an expanded view of a portion of the physical memory of FIG. 3.

FIG. 5 is a flow chart of one implementation of a method for selecting a memory block to store data.

### DETAILED DESCRIPTION OF THE DRAWINGS

The present disclosure is directed to systems and methods for choosing a data block for the storage of data based on a frequency with which the data is updated. As discussed above, when opening memory blocks to store data, conventional non-volatile memory systems operate to open a memory block from a free block list within the memory system that is associated with a lowest program/erase cycle count (P/E count). This procedure is inefficient when data that is not frequently updated is stored in a memory block having a low P/E count in comparison to other memory blocks at the memory system. Because the data is not frequently updated, the P/E count associated with the memory block stays low in comparison to other memory blocks and the memory systems will move the data to another memory block when performing wear-leveling operations.

In the non-volatile memory systems discussed below, prior to storing data, a memory management module at a non-volatile memory system examines the data to determine whether the data is frequently updated or infrequently updated. This characteristic of the data is also known as a temperature of the data where hot data is data that is frequently updated and cold data is data that is not frequently updated.

Hot data may occur when data within a memory system is invalidated and an updated version of the data is written several times within a short period of time. Examples of data that is typically frequently updated within a short period of time include File Allocation Table (FAT) data or logical to physical address location data. In some implementations, data is considered hot when a hot count that is associated with a logical block address (LBA) that is associated with the data is high. As known in the art, frequently written data can be tracked by LBA and assigned a hot count which is incremented each time the data is written within a certain frequency/time period.

Conversely, cold data may occur when data within a memory system is written, but then not subsequently modified or changed for an extended period of time. Examples of data that may not be frequently updated include archived data (such as archived emails, photographs, or documents). In some implementations, maintenance operations such as data retention loss monitoring may identify cold data as the data becomes stale. To identify stale data, memory systems may utilize features such as timepools that include memory blocks that were last refreshed or rewritten during the same time period.

After determining how frequently the data is updated, the memory management module opens a memory block on one or more of a free block list, a free block pool, or some other grouping of available memory blocks at the memory system to store the data based on the temperature of the data. As discussed in more detail below, the memory management module generally operates to store hot data in memory blocks with low relative P/E counts and to store cold data in memory blocks with high relative P/E counts. By matching data with a memory block based on these factors, a number of wear-leveling operations that the non-volatile memory system must perform is reduced, thereby improving an endurance of the memory system.

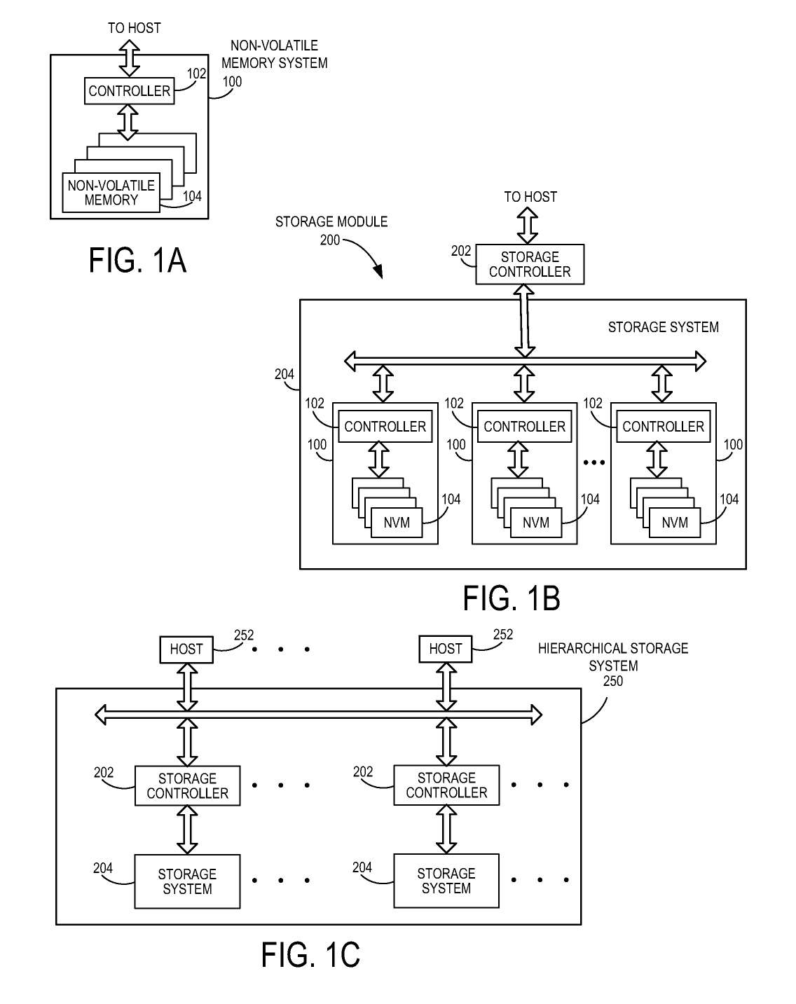

Memory systems suitable for use in implementing aspects of these embodiments are shown in FIGS. 1A-1C. FIG. 1A is a block diagram illustrating a non-volatile memory system according to an embodiment of the subject matter described herein. Referring to FIG. 1A, non-volatile memory system 100 includes a controller 102 and non-volatile memory that may be made up of one or more non-volatile memory die 104. As used herein, the term die refers to the collection of non-volatile memory cells, and associated circuitry for managing the physical operation of those non-volatile memory cells, that are formed on a single semiconductor substrate. Controller 102 interfaces with a host system and transmits command sequences for read, program, and erase operations to non- volatile memory die 104.

The controller 102 (which may be a flash memory controller) can take the form of processing circuitry, a microprocessor or processor, and a computer-readable medium that stores computer-readable program code (e.g., software or firmware) executable by the (micro)processor, logic gates, switches, an application specific integrated circuit (ASIC), a programmable logic controller, and an embedded microcontroller, for example. The controller 102 can be configured with hardware and/or firmware to perform the various functions described below and shown in the flow diagrams. Also, some of the components shown as being internal to the controller can also be stored external to the controller, and other components can be used. Additionally, the phrase “operatively in communication with” could mean directly in communication with or indirectly (wired or wireless) in communication with through one or more components, which may or may not be shown or described herein.

As used herein, a flash memory controller is a device that manages data stored on flash memory and communicates with a host, such as a computer or electronic device. A flash memory controller can have various functionality in addition to the specific functionality described herein. For example, the flash memory controller can format the flash memory to ensure the memory is operating properly, map out bad flash memory cells, and allocate spare cells to be substituted for future failed cells. Some part of the spare cells can be used to hold firmware to operate the flash memory controller and implement other features. In operation, when a host needs to read data from or write data to the flash memory, it will communicate with the flash memory controller. If the host provides a logical address to which data is to be read/written, the flash memory controller can convert the logical address received from the host to a physical address in the flash memory. (Alternatively, the host can provide the physical address.) The flash memory controller can also perform various memory management functions, such as, but not limited to, wear leveling (distributing writes to avoid wearing out specific blocks of memory that would otherwise be repeatedly written to) and garbage collection (after a block is full, moving only the valid pages of data to a new block, so the full block can be erased and reused).

Non-volatile memory die 104 may include any suitable non-volatile storage medium, including NAND flash memory cells and/or NOR flash memory cells. The memory cells can take the form of solid-state (e.g., flash) memory cells and can be one-time programmable, few-time programmable, or many-time programmable. The memory cells can also be single-level cells (SLC), multiple-level cells (MLC), triple-level cells (TLC), or use other memory technologies, now known or later developed. Also, the memory cells can be arranged in a two- dimensional or three-dimensional fashion.

The interface between controller 102 and non-volatile memory die 104 may be any suitable flash interface, such as Toggle Mode 200, 400, or 800. In one embodiment, memory system 100 may be a card based system, such as a secure digital (SD) or a micro secure digital (micro-SD) card. In an alternate embodiment, memory system 100 may be part of an embedded memory system.

Although, in the example illustrated in FIG. 1A, non-volatile memory system 100 includes a single channel between controller 102 and non-volatile memory die 104, the subject matter described herein is not limited to having a single memory channel. For example, in some NAND memory system architectures, 2, 4, 8 or more NAND channels may exist between the controller and the NAND memory device, depending on controller capabilities. In any of the embodiments described herein, more than a single channel may exist between the controller and the memory die, even if a single channel is shown in the drawings.

FIG. 1B illustrates a storage module 200 that includes plural non-volatile memory systems 100. As such, storage module 200 may include a storage controller 202 that interfaces with a host and with storage system 204, which includes a plurality of non-volatile memory systems 100. The interface between storage controller 202 and non-volatile memory systems 100 may be a bus interface, such as a serial advanced technology attachment (SATA) or peripheral component interface express (PCIe) interface. Storage module 200, in one embodiment, may be a solid state drive (SSD), such as found in portable computing devices, such as laptop computers, and tablet computers.

FIG. 1C is a block diagram illustrating a hierarchical storage system. A hierarchical storage system 250 includes a plurality of storage controllers 202, each of which controls a respective storage system 204. Host systems 252 may access memories within the storage system via a bus interface. In one embodiment, the bus interface may be a non-volatile memory express (NVMe) or a fiber channel over Ethernet (FCoE) interface. In one embodiment, the system illustrated in FIG. 1C may be a rack mountable mass storage system that is accessible by multiple host computers, such as would be found in a data center or other location where mass storage is needed.

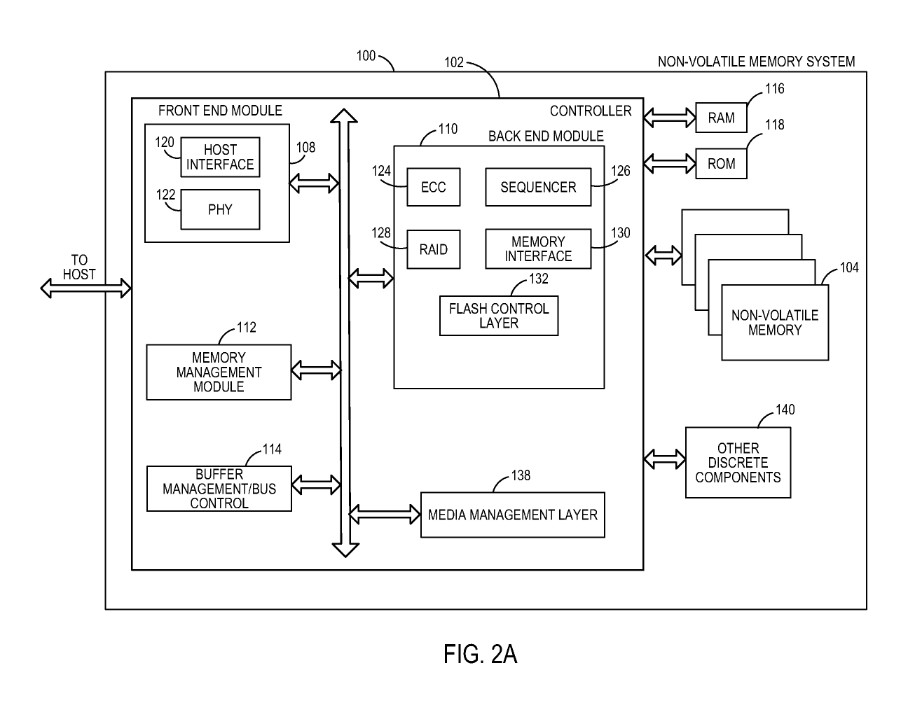

FIG. 2A is a block diagram illustrating exemplary components of controller 102 in more detail. Controller 102 includes a front end module 108 that interfaces with a host, a back end module 110 that interfaces with the one or more non-volatile memory die 104, and various other modules that perform functions which will now be described in detail. A module may take the form of a packaged functional hardware unit designed for use with other components, a portion of a program code (e.g., software or firmware) executable by a (micro)processor or processing circuitry that usually performs a particular function of related functions, or a self-contained hardware or software component that interfaces with a larger system, for example.

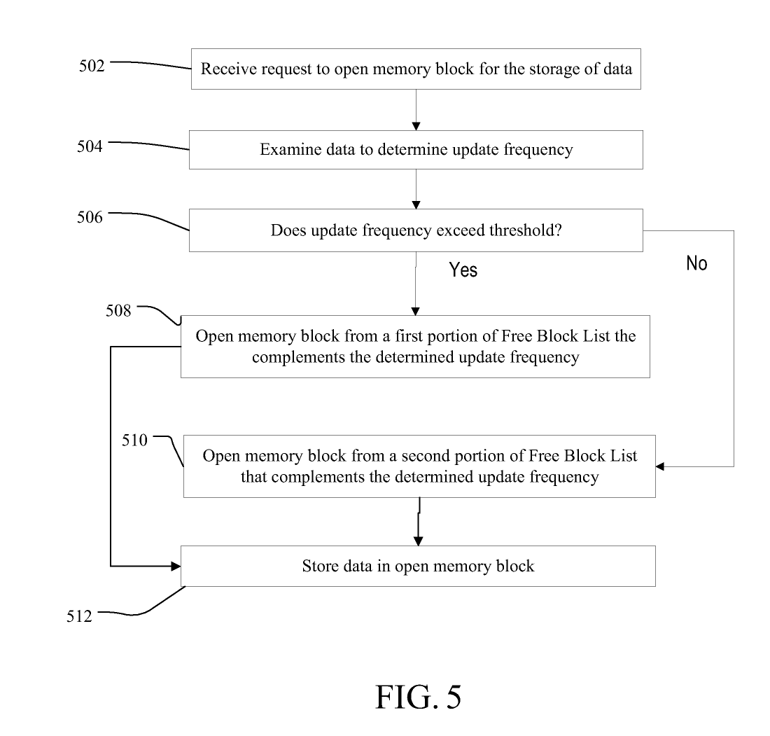

Modules of the controller 102 may include a memory management module 112 present on the die of the controller 102. As explained in more detail below in conjunction with FIG. 5, the memory management module 112 may perform operations to examine data to determine whether the data is frequently updated or infrequently updated and then open a memory block on one or more of a free block list, a free block pool, and/or some other grouping of available memory blocks at the memory system to store the data based on the frequency with which the data is updated. The memory management module 112 generally operates to store frequently updated data (also known as hot data) in memory blocks with low relative P/E counts and to store infrequently updated data (also known as cold data) in memory blocks with high relative P/E counts. By matching data with a memory block based on these factors, a number of wear-leveling operations that the memory system must perform is reduced, thereby improving an endurance of the memory system.

Referring again to modules of the controller 102, a buffer manager/bus controller 114 manages buffers in random access memory (RAM) 116 and controls the internal bus arbitration of controller 102. A read only memory (ROM) 118 stores system boot code. Although illustrated in FIG. 2A as located separately from the controller 102, in other embodiments one or both of the RAM 116 and ROM 118 may be located within the controller. In yet other embodiments, portions of RAM and ROM may be located both within the controller 102 and outside the controller. Further, in some implementations, the controller 102, RAM 116, and ROM 118 may be located on separate semiconductor die.

Front end module 108 includes a host interface 120 and a physical layer interface (PHY) 122 that provide the electrical interface with the host or next level storage controller. The choice of the type of host interface 120 can depend on the type of memory being used. Examples of host interfaces 120 include, but are not limited to, SATA, SATA Express, SAS, Fibre Channel, USB, PCIe, and NVMe. The host interface 120 typically facilitates transfer for data, control signals, and timing signals.

Back end module 110 includes an error correction controller (ECC) engine 124 that encodes the data bytes received from the host, and decodes and error corrects the data bytes read from the non-volatile memory. A command sequencer 126 generates command sequences, such as program and erase command sequences, to be transmitted to non-volatile memory die 104. A RAID (Redundant Array of Independent Drives) module 128 manages generation of RAID parity and recovery of failed data. The RAID parity may be used as an additional level of integrity protection for the data being written into the non- volatile memory system 100. In some cases, the RAID module 128 may be a part of the ECC engine 124. A memory interface 130 provides the command sequences to non-volatile memory die 104 and receives status information from non-volatile memory die 104. In one embodiment, memory interface 130 may be a double data rate (DDR) interface, such as a Toggle Mode 200, 400, or 800 interface. A flash control layer 132 controls the overall operation of back end module 110.

Additional components of system 100 illustrated in FIG. 2A include media management layer 138, which performs wear leveling of memory cells of non-volatile memory die 104. System 100 also includes other discrete components 140, such as external electrical interfaces, external RAM, resistors, capacitors, or other components that may interface with controller 102. In alternative embodiments, one or more of the physical layer interface 122, RAID module 128, media management layer 138 and buffer management/bus controller 114 are optional components that are not necessary in the controller 102.

FIG. 2B is a block diagram illustrating exemplary components of non-volatile memory die 104 in more detail. Non-volatile memory die 104 includes peripheral circuitry 141 and non-volatile memory array 142. Non-volatile memory array 142 includes the non-volatile memory cells used to store data. The non-volatile memory cells may be any suitable non-volatile memory cells, including NAND flash memory cells and/or NOR flash memory cells in a two dimensional and/or three dimensional configuration. Peripheral circuitry 141 includes a state machine 152 that provides status information to controller 102. Non-volatile memory die 104 further includes a data cache 156 that caches data.

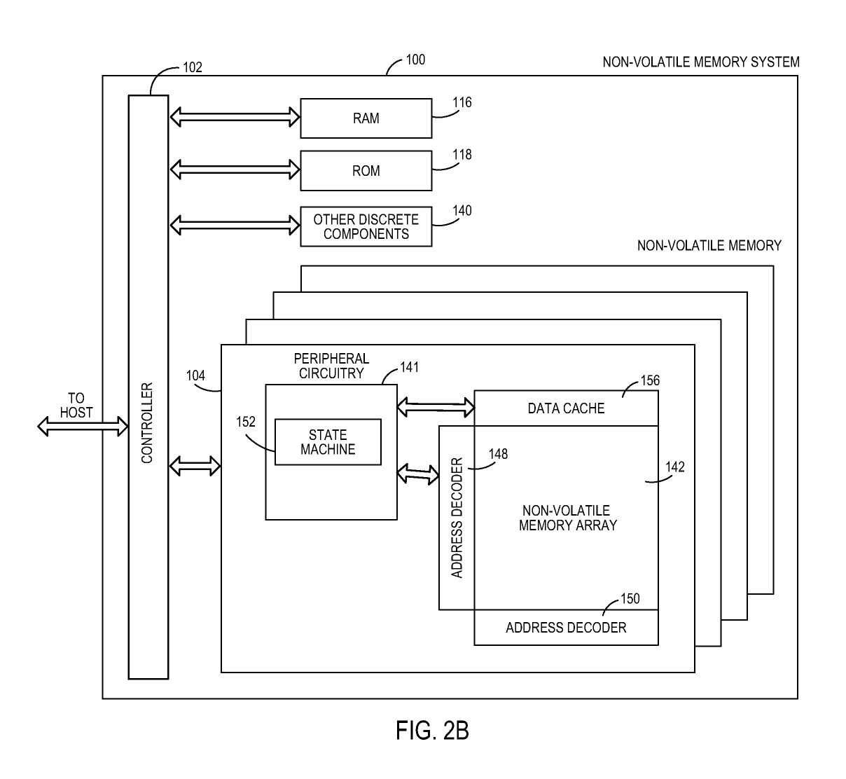

FIG. 3 conceptually illustrates a multiple plane arrangement showing four planes 502-508 of memory cells. These planes 302-308 may be on a single die, on two die (two of the planes on each die) or on four separate die. Of course, other numbers of planes, such as 1, 2, 8, 16 or more may exist in each die of a system. The planes are individually divided into blocks of memory cells shown in FIG. 3 by rectangles, such as blocks 310, 312, 314 and 316, located in respective planes 302-308. There can be dozens or hundreds or thousands or more of blocks in each plane.

As mentioned above, a block of memory cells is the unit of erase, the smallest number of memory cells that are physically erasable together. Some non-volatile memory systems, for increased parallelism, operate the blocks in larger metablock units. However, other memory systems may utilize asynchronous memory die formations rather than operating in larger metablock units.

In non-volatile memory systems utilizing metablock units, one block from each plane is logically linked together to form the metablock. The four blocks 310-316 are shown to form one metablock 318. All of the cells within a metablock are typically erased together. The blocks used to form a metablock need not be restricted to the same relative locations within their respective planes, as is shown in a second metablock 320 made up of blocks 322-328. Although it is usually preferable to extend the metablocks across all of the planes, for high system performance, the non-volatile memory systems can be operated with the ability to dynamically form metablocks of any or all of one, two or three blocks in different planes. This allows the size of the metablock to be more closely matched with the amount of data available for storage in one programming operation.

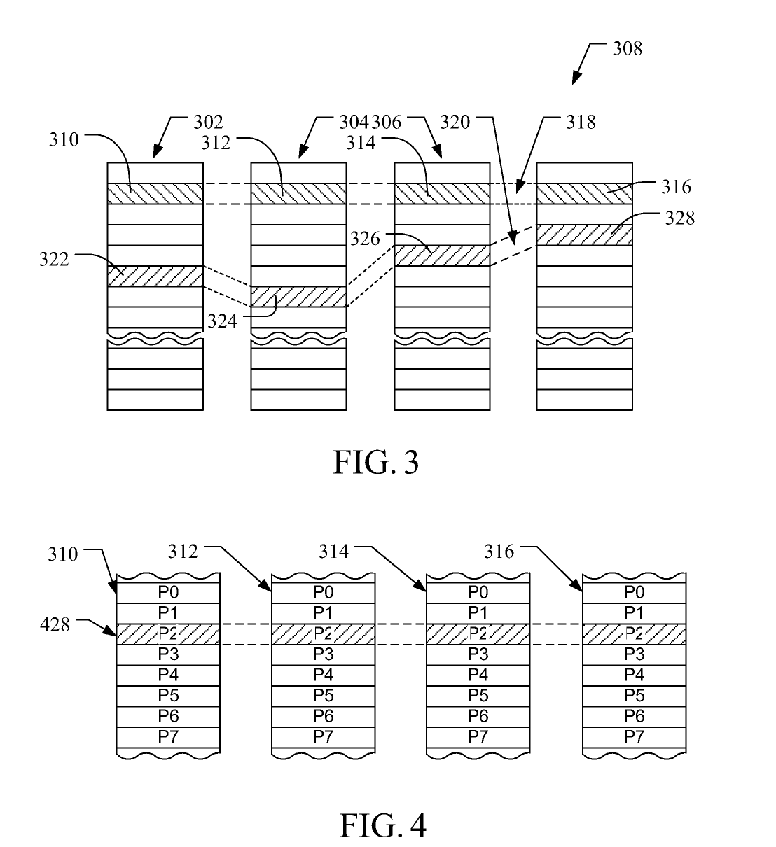

The individual blocks are in turn divided for operational purposes into pages of memory cells, as illustrated in FIG. 4. The memory cells of each of the blocks 310-316, for example, are each divided into eight pages P0-P7. Alternatively, there may be 32, 64 or more pages of memory cells within each block. The page is the unit of data programming and reading within a block, containing the minimum amount of data that are programmed or read at one time. However, in order to increase the memory system operational parallelism, such pages within two or more blocks may be logically linked into metapages. A metapage 428 is illustrated in FIG. 4, being formed of one physical page from each of the four blocks 310-316. The metapage 428, for example, includes the page P2 in each of the four blocks but the pages of a metapage need not necessarily have the same relative position within each of the blocks.

As mentioned above, non-volatile memory systems described in the present application may, prior to storing data, examine the data to determine whether the data is frequently updated or infrequently updated, also known as determining a temperature of data. After determining how frequently the data is updated, a memory management module of the memory system identifies a memory block on a free block list, a free block pool, or some other grouping of available memory blocks that compliments a temperature of the data and stores the memory in the identified block.

A free block list is generally a listing within the non-volatile memory system that a memory management module maintains that includes memory blocks within the memory system that do not contain valid data and are available to store data. In some implementations, the free block list is part of a Group Address Table that a memory management module maintains within the memory system, where the Group Address Table maps logical block addresses to physical block addresses. In addition to the free block list the memory management module may also maintain a listing of functions that the controller and/or other modules within the memory system may operate on the memory blocks on the free block list, such as selecting a memory block, opening a memory block, closing a memory block, grouping a memory block, or ungrouping a memory block.

In some implementations, a memory management module may utilize a data structure other than a free block list such as a free block pool or some other grouping of memory blocks that are available at the memory system. Like the free block list, the free block pool may include memory blocks within the memory system that do not contain valid data and are available to store data. However, the free block pool is not in the form of a list.

The memory management module may rank memory blocks on a free block list in terms of a number of program/erase cycles (P/E count) associated with a memory block and/or any other metric such as block age, block health, or block longevity that generally identifies how many more cycles a memory block can withstand (how much life a memory block potentially has left) compared to other memory blocks. A memory block at a beginning of the list, also known as a head of the list, is typically associated with a lowest P/E count and a block at an end of the list, also known as a tail of list, is typically associated with a highest P/E count.

It will be appreciated that a low P/E count is indicative of a memory block that has not been utilized as much as other blocks or has higher longevity than other blocks. This could be a result of the physical characteristics of the memory block that allow it to endure more P/E cycles than other blocks. Alternatively, a high P/E count is indicative of a memory block that has been erased and written to more often than other blocks or that has a shorter life span than other memory blocks within the memory system.

The memory management module generally operates to store data that is frequently updated (hot data) in memory blocks with a low relative P/E count and to store data that is not frequently updated (cold data) in memory blocks with a high relative P/E count. By matching data with a memory block based on these factors, a number of wear-leveling operations that the memory system must perform is reduced, thereby improving an endurance of the memory system. The number of wear-leveling operations is reduced because the memory management module is preemptively preventing memory blocks with relative low P/E counts from staying low due to cold data that is not frequently updated and preemptively preventing memory blocks with relative high P/E counts from staying high due to hot data that is frequently updated.

FIG. 5 is a flow chart of one implementation of a method for selecting a memory block to store data based on a frequency with which the data is updated. At step 502, a memory management module of the non-volatile memory system receives a request to open a free memory block for the storage of data. The request to open a free memory block may be the result of a host system sending a write command to the memory system, the memory management module and media management layer performing a garbage collection operation or a wear-leveling operation to relocate data within the non-volatile memory system, or any other operation that may result in the controller of the memory system storing data at the memory system.

At step 504, the memory management module examines the data to determine a frequency with which the data is updated, also known as a temperature of the data. In some implementations, the memory management module may determine the frequency with which the data is updated by examining metadata associated with the data, tables stored at the memory system that indicate information such as “hot counts” for logical units or logical block addresses, and/or a history of a last x number of commands; and/or by the memory management module actually tracking logical units which have been written/overwritten several times.

At step 506, the memory management module compares the determined frequency with which the data is updated to a threshold. The memory management module compares the determined frequency with which the data is updated to the threshold in order to identify a group of memory blocks on a free block list that complement a temperature of the data.

When the determined frequency with which the data is updated exceeds a threshold, at step 508 the memory management module opens a memory block from a first portion of the free block list that complements the temperature of the data. Alternatively, when the determined frequency with which the data is updated does not exceed the threshold, at step 510 the memory management module opens a memory block from a second different portion of the free block list that complements the temperature of the data.

For example, in one implementation, the memory management module compares the frequency with which the data is updated to a threshold in order to determine whether the data is cold data or hot data. When the frequency with which the data is updated does not exceed the threshold, thereby indicating that the data is cold data, the memory management module opens a block from a first portion of the free block list with a high relative P/E count.

It will be appreciated that because the cold data is stored in a memory block with a high relative P/E count, the data in the memory block will likely not be updated for some time and the memory management module will not need to move the data within the memory block in the near future for a wear-leveling operation while the other memory blocks within the memory system are utilized until a P/E count of the other memory blocks move towards the high P/E count memory block which now contains cold data.

Alternatively, when the frequency with which the data is updated exceeds the threshold, thereby indicating that the data is hot data, the controller opens a block from a second different portion of the free block list with a low relative P/E count. It will be appreciated that because the hot data is frequently updated, as the memory management module updates the hot data the P/E count of the memory block will increase and move towards an average P/E count of the memory blocks within the memory system.

In some implementations, the first and second portions of the free block list are different halves of the free block list. For example, with respect to cold data, if the free block list contains 100 memory blocks, the controller may select a memory block from the 50 memory blocks on the free block list with the highest P/E counts. Depending on the implementation, the controller may select a memory block from the portion of the free block list that is associated with a highest P/E count; select a memory block that is associated with a second highest P/E count; select a memory block associated with a P/E count closest to a median P/E count of the memory blocks within the portion of the free block list; randomly select a memory block from the memory blocks within the portion of the free block list; select a memory block from the portion of the free block list that has been on the free block list the longest; or any other pattern that allows the controller to select a memory block for the storage of data that complements a temperature of the data.

Continuing with the same example, with respect to hot data and the same Free Bock List containing 100 blocks memory blocks, the controller may select a memory block from the 50 memory blocks on the free block list with the lowest P/E counts. Depending on the implementation, the controller may select a memory block from the portion of the free block list that is associated with a lowest P/E count; select a memory block that is associated with a second lowest P/E count; select a memory block associated with a P/E count closest to a median P/E count of the memory blocks within the portion of the free block list; randomly select a memory block from the memory blocks within the portion of the free block list; select a memory block from the portion of the free block list that has been on the free block list the longest; or any other pattern that allows the controller to select a memory block for the storage of data that complements a temperature of the data.

After opening a memory block at step 508 or 510, the memory management module stores the data in the opened memory block at step 512.

In the implementations described above, a memory management module compares a frequency with which data is updated to a threshold to determine if the data is hot or cold, and the memory management module then opens a memory block from a first portion or a second different portion of a free block list in order to store the data in a memory block that complements the temperature of the data. However, it will be appreciated that in other implementations, the memory management module may examine how often data is updated to classify the temperature of data in more than two characterizations. Further, the free block list may be divided into more than two portions to complement the different characterizations of the data.

For example, a controller may determine a frequency with which data will be updated, and compare that frequency to multiple thresholds to determine whether to classify the temperature of the data as super hot, hot, cold, or super cold. In this example, the free block list is divided into four portions to complement the four classifications of data.

Continuing with the example above where a free block list contains 100 memory blocks ranked in terms of a P/E count associated with the memory block, when the controller determines the data is superhot, the controller opens a memory block from a first portion of the free block list that includes a set of 25 memory blocks that are associated with the lowest P/E counts.

Moving sequentially through the temperature characterization of the data, when the controller determines the data is hot, the controller opens a memory block from a second portion of the free block list that includes a next set of 25 memory blocks that are associated with the next set of the P/E counts; when the controller determines the data is cold, the controller opens a memory block from a third portion of the free block list that includes a next set of 25 memory blocks that are associated with the next set of the P/E counts; and when the controller determines the data is super cold, the controller opens a memory block from a fourth portion of the free block list that includes a final fourth set of 25 memory blocks that are associated with the last set of the P/E counts.

In the implementations described above, the number of memory blocks in each portion of the free block list is equal. However, it will be appreciated that in other implementations, different portions of the free block list may include a different number of memory blocks. For example, for a free block list containing 100 memory blocks, a first portion of the free block list containing memory blocks with the highest P/E counts may contain 60 memory blocks while a second portion of the free block list containing memory blocks with the lowest P/E counts may contain 40 memory blocks.

Additionally, in the implementations described above, the free block list is described as a sequential list. However, it will be appreciated that in other implementations, other data structures may be utilized such as a circular array or a general pool.

In the methods described above, the memory management module compares a frequency with which data is updated to a threshold in order to identify a portion of a free block list to open a memory block that will complement with the frequency with which data is updated. In other implementations, similar methods may be utilized that do not use thresholds. For example, by default a memory management module may open a memory block from a first portion of a free block list to store data unless the memory management module knows that particular data is not frequently updated (cold data).

For example, the memory management module may determine a need to open a memory block in response to a wear-leveling operation or as a result of increasing errors from data reads of stale data due to data retention loss or due to read disturbances. The memory management module may implicitly know that as a result, the data to be stored in the memory block is cold data. Rather than opening a memory block from the first portion of the free block list according to the default position, when the memory management module open a memory block in response to these actions the memory management module opens a memory block from a second portion of the free block list that includes memory blocks associated with relatively high P/E counts. Accordingly, the memory management layer still operates to store data in a memory block that complements a frequency with which the data is updated, but without specifically comparing a frequency with which the data is updated to a threshold.

FIGS. 1-5 illustrate systems and methods for choosing a memory block for the storage of data based on a frequency with which the data is updated. These methods for the selection of a free memory block may be utilized within all memory system architectures in which memory management modules make an active choice of which memory block to open for the storage of data. Generally, a memory management module of a non-volatile memory system examines data to determine how often the data is updated. In order to avoid unnecessary operations associated with wear leveling operations, the memory management module preemptively stores data that is frequently updated in memory blocks that are associated with relatively low program/erase cycle counts (P/E counts) and stores data that is infrequently updated in memory blocks that are associated with relatively high P/E counts.

It is intended that the foregoing detailed description be regarded as illustrative rather than limiting, and that it be understood that it is the following claims, including all equivalents, that are intended to define the spirit and scope of this invention.

For example, in the present application, semiconductor memory devices such as those described in the present application may include volatile memory devices, such as dynamic random access memory (“DRAM”) or static random access memory (“SRAM”) devices, non-volatile memory devices, such as resistive random access memory (“ReRAM”), electrically erasable programmable read only memory (“EEPROM”), flash memory (which can also be considered a subset of EEPROM), ferroelectric random access memory (“FRAM”), and magnetoresistive random access memory (“MRAM”), and other semiconductor elements capable of storing information. Each type of memory device may have different configurations. For example, flash memory devices may be configured in a NAND or a NOR configuration.

The memory devices can be formed from passive and/or active elements, in any combinations. By way of non-limiting example, passive semiconductor memory elements include ReRAM device elements, which in some embodiments include a resistivity switching storage element, such as an anti-fuse, phase change material, etc., and optionally a steering element, such as a diode, etc. Further by way of non-limiting example, active semiconductor memory elements include EEPROM and flash memory device elements, which in some embodiments include elements containing a charge storage region, such as a floating gate, conductive nanoparticles, or a charge storage dielectric material.

Multiple memory elements may be configured so that they are connected in series or so that each element is individually accessible. By way of non-limiting example, flash memory devices in a NAND configuration (NAND memory) typically contain memory elements connected in series. A NAND memory array may be configured so that the array is composed of multiple strings of memory in which a string is composed of multiple memory elements sharing a single bit line and accessed as a group. Alternatively, memory elements may be configured so that each element is individually accessible, e.g., a NOR memory array. NAND and NOR memory configurations are exemplary, and memory elements may be otherwise configured.

The semiconductor memory elements located within and/or over a substrate may be arranged in two or three dimensions, such as a two dimensional memory structure or a three dimensional memory structure.

In a two dimensional memory structure, the semiconductor memory elements are arranged in a single plane or a single memory device level. Typically, in a two dimensional memory structure, memory elements are arranged in a plane (e.g., in an x-z direction plane) which extends substantially parallel to a major surface of a substrate that supports the memory elements. The substrate may be a wafer over or in which the layer of the memory elements are formed or it may be a carrier substrate which is attached to the memory elements after they are formed. As a non-limiting example, the substrate may include a semiconductor such as silicon.

The memory elements may be arranged in the single memory device level in an ordered array, such as in a plurality of rows and/or columns. However, the memory elements may be arrayed in non-regular or non-orthogonal configurations. The memory elements may each have two or more electrodes or contact lines, such as bit lines and word lines.

A three dimensional memory array is arranged so that memory elements occupy multiple planes or multiple memory device levels, thereby forming a structure in three dimensions (i.e., in the x, y and z directions, where the y direction is substantially perpendicular and the x and z directions are substantially parallel to the major surface of the substrate).

As a non-limiting example, a three dimensional memory structure may be vertically arranged as a stack of multiple two dimensional memory device levels. As another non-limiting example, a three dimensional memory array may be arranged as multiple vertical columns (e.g., columns extending substantially perpendicular to the major surface of the substrate, i.e., in the y direction) with each column having multiple memory elements in each column. The columns may be arranged in a two dimensional configuration, e.g., in an x-z plane, resulting in a three dimensional arrangement of memory elements with elements on multiple vertically stacked memory planes. Other configurations of memory elements in three dimensions can also constitute a three dimensional memory array.

By way of non-limiting example, in a three dimensional NAND memory array, the memory elements may be coupled together to form a NAND string within a single horizontal (e.g., x-z) memory device levels. Alternatively, the memory elements may be coupled together to form a vertical NAND string that traverses across multiple horizontal memory device levels. Other three dimensional configurations can be envisioned wherein some NAND strings contain memory elements in a single memory level while other strings contain memory elements which span through multiple memory levels. Three dimensional memory arrays may also be designed in a NOR configuration and in a ReRAM configuration.

Typically, in a monolithic three dimensional memory array, one or more memory device levels are formed above a single substrate. Optionally, the monolithic three dimensional memory array may also have one or more memory layers at least partially within the single substrate. As a non-limiting example, the substrate may include a semiconductor such as silicon. In a monolithic three dimensional array, the layers constituting each memory device level of the array are typically formed on the layers of the underlying memory device levels of the array. However, layers of adjacent memory device levels of a monolithic three dimensional memory array may be shared or have intervening layers between memory device levels.

Then again, two dimensional arrays may be formed separately and then packaged together to form a non-monolithic memory device having multiple layers of memory. For example, non-monolithic stacked memories can be constructed by forming memory levels on separate substrates and then stacking the memory levels atop each other. The substrates may be thinned or removed from the memory device levels before stacking, but as the memory device levels are initially formed over separate substrates, the resulting memory arrays are not monolithic three dimensional memory arrays. Further, multiple two dimensional memory arrays or three dimensional memory arrays (monolithic or non-monolithic) may be formed on separate chips and then packaged together to form a stacked-chip memory device.

Associated circuitry is typically required for operation of the memory elements and for communication with the memory elements. As non-limiting examples, memory devices may have circuitry used for controlling and driving memory elements to accomplish functions such as programming and reading. This associated circuitry may be on the same substrate as the memory elements and/or on a separate substrate. For example, a controller for memory read-write operations may be located on a separate controller chip and/or on the same substrate as the memory elements.

One of skill in the art will recognize that this invention is not limited to the two dimensional and three dimensional exemplary structures described but cover all relevant memory structures within the spirit and scope of the invention as described herein and as understood by one of skill in the art.

1. In a memory management module of a non-volatile memory system that is coupled with a host device, a method comprising:
receiving a request to open a free memory block of a non-volatile memory of the non-volatile memory system for the storage of data;
determining a frequency with which the data is updated;
opening a memory block of a first portion a free block list that is associated with low program/erase cycle counts in response to determining that the data will be frequently updated;
opening a memory block of a second different portion of the free block list that is associated with high program/erase cycle counts in response to determining that the data is not frequently updated; and
storing the data in the open memory block of the non-volatile memory.

2. The method of claim 1, wherein opening a memory block of a first portion a free block list that is associated with low program/erase cycle counts in response to determining that the data will be frequently updated comprises opening a memory block with a lowest program/erase cycle count on the free block list; and
wherein opening a memory block of a second different portion of the free block list that is associated with high program/erase cycle counts in response to determining that the data is not frequently updated comprises opening a memory block with a highest program/erase cycle count on the free block list.

3. The method of claim 1, wherein opening a memory block of a first portion a free block list that is associated with low program/erase cycle counts in response to determining that the data will be frequently updated comprises randomly selecting a memory block from the first portion of memory blocks to open; and
wherein opening a memory block of a second different portion of the free block list that is associated with high program/erase cycle counts in response to determining that the data is not frequently updated comprises randomly selecting a memory block from the second portion of memory blocks to open.

4. The method of claim 1, where a number of memory blocks in the first portion of the free block list is different than a number of memory blocks in the second portion of the free block list.

5. The method of claim 1, wherein the free block list comprises a circular array ranked in order of a program/erase cycle count associated with each memory block.

6. The method of claim 1, wherein the free block list comprises a linear array ranked in order of a program/erase cycle count associated with each memory block.

7. The method of claim 1, wherein the non-volatile memory comprises a silicon substrate and a plurality of memory cells forming at least two memory layers vertically disposed with respect to each other to form a monolithic three-dimensional structure, wherein at least one layer is vertically disposed with respect to the silicon substrate.

8. An apparatus comprising:
non-volatile memory; and
processing circuitry in communication with the non-volatile memory, the processing circuitry comprising:
a memory management module configured to determine a frequency with which data is updated, select a memory block of the non-volatile memory to store the data based on an indication of how many further program/erase cycles that a block of memory can sustain and how frequently the data is updated, and open the selected memory block and store the data at the selected memory block of non-volatile memory.

9. The apparatus of claim 8, wherein the memory management module is configured to select the memory block to store the data from a free block list that is ranked in order of program/erase cycle counts associated with each memory block.

10. The apparatus of claim 9, where to select a memory block to store the data, the memory management module is configured to randomly select a memory block from a portion of the free block list that includes memory blocks associated with program/erase cycle counts that complement the frequency with which the data is updated.

11. The apparatus of claim 9, wherein the free block list is a circular array.

12. The apparatus of claim 8, wherein the non-volatile memory comprises a silicon substrate and a plurality of memory cells forming at least two memory layers vertically disposed with respect to each other to form a monolithic three-dimensional structure, wherein at least one layer is vertically disposed with respect to the silicon substrate.

13. In a memory management module of a non-volatile memory system coupled to a host device, a method comprising:
classifying data based on a temperature of the data;
selecting a free memory block of a non-volatile memory of the memory system that complements the data based on a program/erase cycle count associated with the memory block and the temperature of the data; and
storing the data at the selected memory block.

14. The method of claim 13, wherein the memory block is selected from a portion of a free block list that includes free memory blocks associated with program/erase cycle counts that complement the temperature of the data.

15. The method of claim 14, wherein the memory block is randomly selected from the portion of the free block list.

16. The method of claim 14, wherein the free block list includes portions to complement at least two temperatures of data.

17. The method of claim 13, wherein selecting a memory block that complements the data comprises selecting a memory block associated with a high relative program/erase cycle count to complement cold data.

18. The method of claim 13, wherein selecting a memory block that complements the data comprises selecting a memory block associated with a low relative program/erase cycle count to complement hot data.

19. The method of claim 13, wherein the non-volatile memory comprises a silicon substrate and a plurality of memory cells forming at least two memory layers vertically disposed with respect to each other to form a monolithic three-dimensional structure, wherein at least one layer is vertically disposed with respect to the silicon substrate.
